(19) United States
(12) Patent Application Publication
(10) Pub. No.: US 2015/0134440 A1
(43) Pub. Date: May 14, 2015

(54) System And Method For Managing The Consumption Of Power Generated From Renewable And Environmentally Friendly Sources

(71) Applicant: Francesco Maria Vespasiani, Roma (IT)

(72) Inventor: Francesco Maria Vespasiani, Roma (IT)

(21) Appl. No.: 14/398,233

(22) PCT Filed: May 1, 2013
(86) PCT No.: PCT/IB2013/053450

§ 371 Date: Oct. 31, 2014

(30) Foreign Application Priority Data
May 2, 2012 (IT) BO2012A 000235

(51) Int. Cl. G06Q 10/00; G06Q 50/06; G06Q 30/02

(52) U.S. Cl. CPC G06Q 10/30; G06Q 30/0226; G06Q 50/06
USPC 705/14.27

(57) ABSTRACT

The present system manages the consumption of ‘green’ energy introduced into a power distribution network together with the energy obtained from other sources, distributed to predetermined delivery points. The green energy is associated to RECS certificates of origin, whose economic value is proportioned to the energy production. The power distribution network includes at least one consumption counter for computing the total energy consumption in a plant. At least one server is associated with the power distribution network for managing electronic data in one or more communication networks. A collecting device collects credits related to the RECS certificates and a partializer partializes the credits on the basis of purchase orders received from green energy consumers. The current amount of credits purchased by the user is stored, with a deduction from the amount for the part of the credits based on the energy consumption that the user will derive from green sources.

### CROSS REFERENCE TO RELATED APPLICATIONS

This application is a National Stage of PCT International application no. PCT/IB2013/053450, filed 1 May 2013, which claims priority in Italian patent application no. BO2012A 000235, filed 2 May 2012, the contents of these applications being incorporated by reference herein.

### TECHNICAL FIELD

The present invention relates to the technical field concerning the production and distribution of electric energy obtained from renewable or environmentally friendly sources.

In particular, the invention relates to a method and a system for attributing, distributing and computing certificates of guarantee of origin of a given amount of the so-called ‘green’ energy, that is produced from the above mentioned renewable or anyway, environmentally friendly sources and consumed by a user.

### BACKGROUND ART

It is known that nowadays the production of energy from renewable sources, or anyway, from sources having no or very limited environmental impact is given considerable importance. Important examples of electric energy production from renewable sources include hydroelectric, wind, photovoltaic, geothermal plants, etc.

The electric energy produced from the above mentioned sources is certainly more precious intrinsically with respect to that produced from traditional fossil sources, in primis petroleum and natural gas, and an ever increasing necessity is felt for exploiting not only its production, but also its use. Actually, users of energy services are more and more conscious that purchasing and using the energy produced without exploiting fossil resources, without causing further environmental pollution and jeopardizing the future availability of such sources, is the best way to restrain degradation of health conditions of our planet and to assure a still liveable and not too polluted environment also for our progeny.

It has also been shown that quite a big percentage of users is even willing to pay a reasonably higher price for energy derived from not polluting sources.

In practical terms, what has been described above, can build over time a virtuous feedback mechanism in the diffusion and development of the renewable energy technologies. In fact, it is wholly probable that, if an energy producer establishes that the users are more willing to purchase energy derived from renewable and sustainable sources, he is more stimulated to increase the ‘green’ part of his production. Then, he will take this fact into consideration while defining his future investments.

An implicit aspect of the current organization of the energy production and distribution is the fact that both the energy produced in a conventional way and energy derived from renewable and eco sustainable sources are introduced into the same power distribution network, which conveys them to the final users, both industrial and domestic. Therefore, identification of the real origin of the energy made available for the users is in fact impossible. On the other hand, it is inconceivable to assume that parallel capillary power distribution networks will be constructed for distributing the energy derived from renewable sources in a physically separated way.

In order to satisfy the requests of a part of users to use clean energy, on one side, and the producers' interest to show their care to produce it, even at a higher cost of a produced unit, on the other side, a certification system for the part of energy deriving from renewable sources and for the interchange of such certificates among the interested parties, has been created and developed over time. For example, the AIB (Association of Issuing Bodies) promotes the European standardized system for quality certification of green energy, i.e. derived from renewable sources, by means of RECS (Renewable Energy Certificate System) and GO (Guarantee of Origin).

Basically, the issued certificates confirm that a certain amount of electric energy has been produced in compliance with precise regulations for production from renewable and non polluting sources. Such certificates are granted to producers who prove to have observed the specific requests for the foregoing amount of production.

The ‘quality’ credit represented by the certificates can be divided and sold, for example to wholesale dealers, who in turn, can sell them to the final users on the basis of the supplies delivered to the respective delivery points. The purchase of certificates for a certain amount of energy shows that, for this precise amount, the user has in fact used energy derived from renewable and clean sources.

The certificates sold to the final user are counted up and recorded always at the end of a solar year.

Therefore, the delivery of certificates is always associated to a well defined power supply annual contract and indicates a single delivery point, that is the one defined by the electric energy metering device installed in that point by the power provider.

The purchase of the above mentioned certificates by a user causes an increase of costs for power supply to the same user. However, the increased cost is rewarded, especially in case of firms, by an image return that can be advantageously used for promotion and for creation of a reputation as a company that cares about environmental issues.

### SUMMARY OF THE INVENTION

The approach to managing of RECS, GO and other similar certificates has considerable limits, which make them of no interest to private users, and in particular to users who get most satisfaction from the high cost purchase of energy derived from renewable sources only by seeing with their own eyes their consumption, which is non polluting and sustainable.

Actually, the conventional ways of handling certificates include a normal power supply at the delivery point, measuring the delivered energy and calculating the final balance of the renewable energy that the user has purchased or is going to purchase as a part of his/her total energy consumption for the period taken into consideration. In this way, in practice, at the end either of the year or of every quarter, the user will simply have another item, which increases the price to pay, among many others present in the bill. Therefore, in practice, there is no appreciable way to make the user aware of having really consumed, at a certain moment or in a certain period, the energy produced according to ecologically acceptable criterion and technologies.

It is an object of the present invention to propose a system for managing the consumption of energy derived from renewable and environmentally friendly sources, and a corresponding method that carries it out, which allows a user to decide when, how and for which specific application to use an amount of such renewable energy that has been purchased.

Another object of the invention is to propose a system and method which allow separating and making totally independent from each other the tasks relating to energy supply and managing the amounts of renewable and clean energy that a user is going to consume.

The above mentioned objects are wholly obtained in accordance with the contents of the claims by a method and system for managing the consumption of ‘green’ energy, that is energy deriving from renewable and environmentally friendly sources, aimed at being introduced into an power distribution network together with the energy produced by other sources, so as to be distributed therewith, in an undifferentiated way, to predetermined delivery points. The green energy is associated to certificates of origin, for example RECS certificates, whose economic value is proportioned to the energy production. The power distribution network includes, in each delivery point, at least one consumption counter device, aimed at computing the total energy consumption in the plant served thereby.

The system includes: at least one server, in association with the power distribution network, designed to manage electronic data connections over one or more communication networks, collecting means for collecting credits related to said certificates of origin RECS, being operative in the server, and partializer means for partializing the credits on the basis of purchase orders received from the consumers of the green energy.

Storage means for carrying the partialized credits, held by each user, are aimed at storing the current amount of credits purchased by the user and at deducting from the amount the part of credits on the basis of the corresponding energy consumption that the user is going to derive from renewable and environmentally friendly sources.

### BRIEF DESCRIPTION OF THE DRAWINGS

The characteristic features of the invention, as they will appear evident from the claims, are pointed out in the following detailed description, with reference to the enclosed tables of drawings, in which:

FIG. 1 is a general block diagram of the system for managing the consumption of energy derived from renewable sources obtained according to a first embodiment of the present invention;

FIG. 2 is a block diagram of a metering and computing device that belongs to the system of FIG. 1;

FIG. 3 is a general block diagram of the system for managing the consumption of energy derived from renewable sources obtained according to a second embodiment of the present invention.

### DETAILED DESCRIPTION OF THE INVENTION

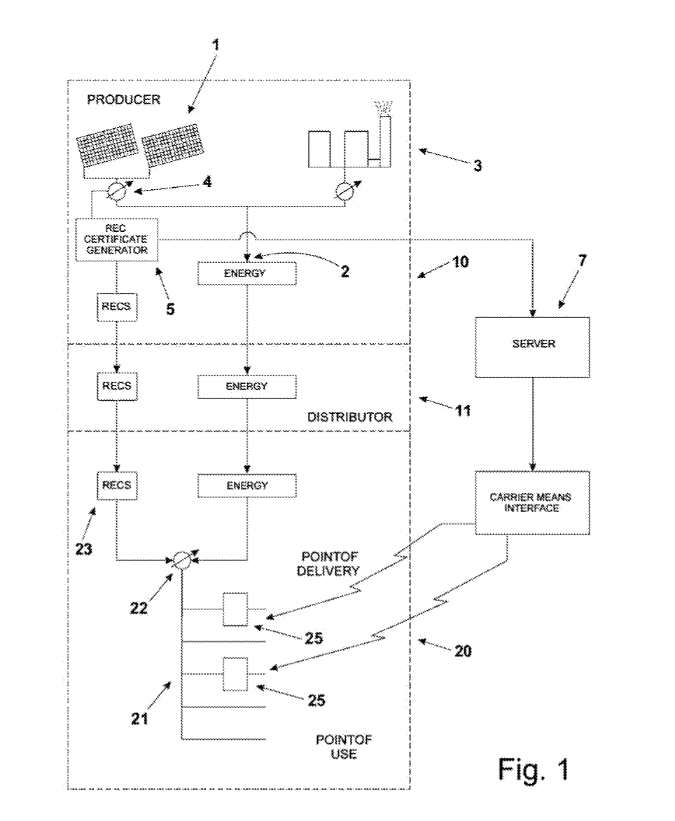

With reference to FIG. 1, there is described hereinafter a first embodiment of a system for managing the consumption of ‘green’ energy, i.e. derived from renewable sources or anyway sources having very limited or even no environmental impact. The diagram of FIG. 1 shows a generator 1 formed by photovoltaic panels. However, it is understood that, for the purposes of the present invention, it is possible to use any environmentally friendly source of energy, whose production can be associated to the RECS or other kind of certificates.

According to the normal structure of a system for generating and distributing energy, the energy produced by the photovoltaic generator 1 and by all the other existent renewable sources, is introduced into a power distribution network 2 together with the energy produced by one or more generators 3 of conventional type, for example, belonging to the same producer.

According to known technologies, downstream of the photovoltaic generator 1, there is a counter device 4 for counting the produced green energy and a device 5 for generating certificates for attribution of such energy, for example RECS certificates. Later on, specific reference will be made to this kind of certificates, however, only for the sake of explanation simplicity.

The energy produced and introduced into the power distribution network is thus generally sold, together with some or all the RECS certificates produced by the given producer, to a distributor 11, who takes care to subsequently resell the energy to a final user at a delivery point 20, and to issue an invoice for it eventually, on the basis of the consumption of the plant 21 associated to this delivery point. For this purpose, a consumption counter device 22 is provided, aimed at computing the energy used by the plant 21. Moreover, the whole supply can be associated, in a conventional way, to a corresponding amount of credits represented by the RECS certificates 23 purchased by the distributor 11, so that the energy used by the plant 21 is recognized as deriving from the photovoltaic generator 1 or from other generators of green energy, for which the RECS certificates, possessed by the distributor 11, have been generated.

According to the invention, the system for managing the consumption of energy produced by the photovoltaic generator 1, includes an independent server 7, including a processor provided with suitable and known connections to one or more global communication networks, for example Internet, the cellular telephone network, etc. The foregoing server 7 belongs to an administrator of the distribution of certificates of origin for a predetermined amount of energy, for example, the above mentioned RECS certificates. According to the invention, this person can be an energy producer 10 or distributor 11, or, in an equally advantageous way, an independent person, whose interests are not involved with the produced energy market, but concern only the credits granted by the RECS certificates.

Besides the operating system and normal procedures for managing the above mentioned communication networks, in the server 7 run also procedures for purchasing and partializing a part or the whole amount of the RECS certificates issued nearby the generator device 5. These procedures are also generally known as collecting means for the credits related to the aforesaid certificates purchased by the administrator of the certificates.

The partialized credits can be purchased from the administrator by users who are going to attribute a selected quantity of their energy consumption directly to ‘green’ production, that is deriving from the photovoltaic generator 1 or from other generators of renewable energy. The purchase and the respective payment can be performed using known conventional channels.

According to a first illustrated embodiment of the invention, the system for managing the consumption of green energy includes, for each delivery point 20, at least an energy metering and computing device 25.

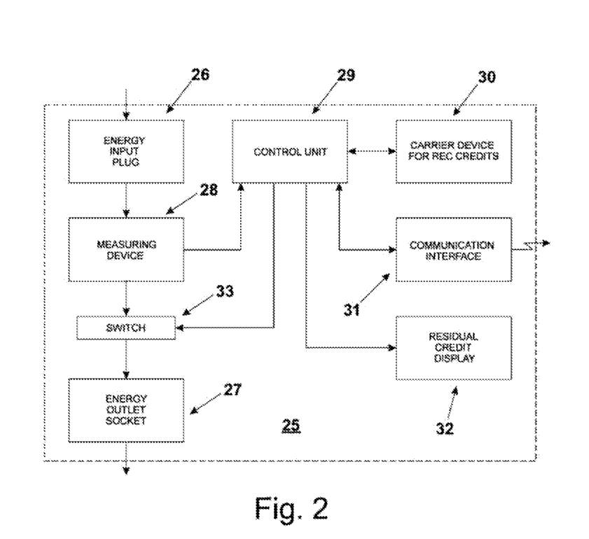

The device 25 (see also the diagram of FIG. 2) includes an input 26 of energy taken from the plant 21 served by the delivery point 20 corresponding to a given user. The input 26 is usually, but not always, formed by a normal plug, adapted to be connected to a corresponding socket provided at a point of use of the plant 21.

The device 25 includes also a power outlet 27, that can be formed, for example, by a standard power socket, aimed at transferring the energy taken by means of the input plug 26 to a load.

Between the input 26 and outlet 27, there is provided a measuring device 28 for measuring the supplied energy, whose circuital configuration can be anyone among those known and available on the market. The metering device which is aimed at counting the quantity of energy withdrawn by means of the metering and computing device 25.

The latter includes also a computerized control unit 29, connected electrically to the aforesaid measuring device 28 and aimed at measuring the energy consumption by means of the metering and computing device 25.

Carrier means 30 are also connected to the control unit 29 for carrying the above mentioned partialized credits, represented by the RECS certificates, registered in the server 7. The amount of such partialized credits substantially corresponds to the purchase orders sent by the user to the server 7.

The metering and computing device 25 includes also an interface 31 for communicating with the communication networks used and accessible by the server 7. The interface is connected with the control unit 29 and is aimed at being controlled by a communication procedure running therein, so as to communicate with the server 7 and receive new partialized credits related to RECS certificates as a result of a purchase by the user.

A particularly important characteristic of the invention lies in the fact that the communication interface 31 is connected in real time with the server 7, for example, through Internet by means of a known ‘wireless’ connection, i.e. a RF connection or through a cellular telephone network interface, via SMS or other known way. In this way, it is possible that the RECS certificates purchased by the user are held in the server 7, and therefore the aforesaid carrier means 30 for carrying credits are formed by a dedicated memory area present in the server 7. Also the detraction of the credits on the basis of consumption can be managed directly by the server 7.

According to another possible embodiment, the carrier means 30 provided in the device 25 are formed by a dedicated permanent memory area, capable of receiving the codes corresponding to the partialized credits owned by the user.

The control unit 29 suitably includes a managing procedure, made according to known programming techniques, capable of withdrawing the current value of the partialized credits receivable by the user from the memory area 30, of recording the value in terms of RECS certificates corresponding to the consumption measured by the metering device 28, of detracting the equivalent from the amount of the partialized credits and storing the remaining value in the memory area 30.

The device 25 can also have a display 32, aimed at displaying the remaining credits present in the memory area 30 or in the server 7, so that the user is always aware when to top up his/her credit.

Actually, another characteristic of the invention lies in the fact that it includes means for converting units of measure, situated in the control unit 29 of the measuring and computing device 25 and formed by a suitable conversion procedure and aimed at converting immediately the readings related to the consumed energy into the corresponding value in terms of certificates and transmitting this value to the display 32.

Optionally, the device 25 can also have a controlled switch 33, connected to the control unit 29 and aimed at interrupting the current supply to the outlet 27, if the credit is used up. In this case, the user can be sure that the whole consumption made through the device 25 will be RECS certificated and consequently, derived from a renewable source.

In practical application, the device 25 is formed by the above described elements enclosed in a suitable container, which can be mounted in the plant 21 in place of one of the points of use provided therein. Alternatively, the device 25 can be provided with a standard input plug and thus it can be wholly portable and independent from the plant 21. In this case, it can be advantageously used by the user in any other plant, completely independently from the supply of energy derived from the distributor 11, and even from the energy derived by a given producer.

According to an alternative version of the above described means for carrying partialized credits RECS 30, they are constituted by an independent memory unit and can be physically removed from the metering and computing device 25, for example a pen drive with re-writable permanent memory, provided with a USB interface. In this way, it can be removed from the device 25, and topped up through other channels, for example, a computer connected to the above mentioned communication networks used by the server 7.

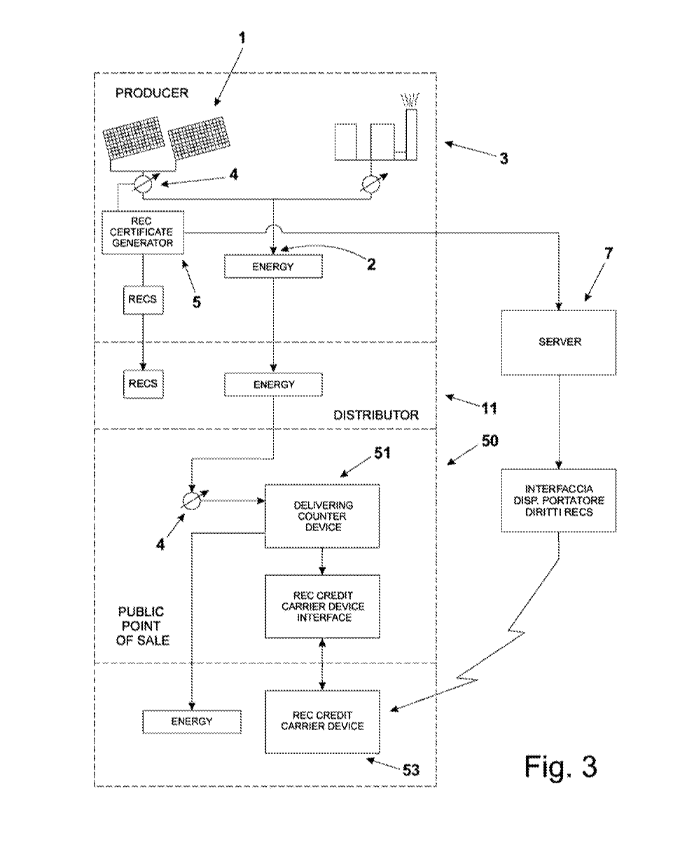

According to a second embodiment of the system in accordance with the invention, illustrated in the diagram of FIG. 3, the delivery point served by the distributor 11, or directly by the producer, is a public energy point of sale 50, or anyway, a point of sale accessible to a plurality of users, for example, a charge station for electric cars. In this case, the delivery point includes an energy delivering-counter device 51, made according to wholly known techniques and capable of delivering electric current and debiting the user, who takes it with the amount calculated according to a basic charge.

The energy delivering-counter device 51 is connected to an interface unit 52 connected to the aforementioned carrier device for partialized credits 53, owned by the user who is taking at this moment the energy from the point of sale 50. Advantageously, in this case, the carrier device for partialized credits 53 is portable as described above, and is preferably formed by a USB memory pen drive, which stores, suitably codified, the current amount of the partialized RECS credits that the user is in credit of. The energy delivering-counter device 51 is provided with a suitable computing procedure for calculating the amount of the partialized RECS credits corresponding to the energy taken by the user and for updating the amount of the aforesaid credits on the carrier device 53.

In practice, when the user introduces the latter device into the interface 52, the sum of the corresponding RECS credits is calculated for the whole amount of the energy taken by the same user, and then, such sum is deduced from the number of the credits present in the carrier device 53.

However, it is obvious that the user can obtain the same result with a portable metering and computing device as described in the first embodiment of the invention, if provided with the input plug compatible with the delivery socket of the point of sale 50.

An advantage of the above described invention lies in the fact that a user who cares about environment problems is offered a system for managing the consumption of energy derived from renewable and environmentally friendly sources, and a corresponding method that carries it out, which allows a user to decide when, how and for which specific application an amount of such renewable energy that he/she has purchased should be used.

Another advantage of the invention derives from the fact that it offers a system and method which allow separating and making wholly independent the tasks of supplying energy and managing the amounts of renewable and clean energy that a user is going to consume.

It is understood that what above has been described as a pure not limiting example. Therefore, possible changes and different versions of the invention are considered within the protective scope granted to the present technical solution, as described above and claimed below.

1-14. (canceled)

15. A system for managing the consumption of green energy derived from renewable and environmentally friendly sources introduced into a distribution network together with energy produced by other sources for undifferentiated distribution therewith to a plurality of predetermined delivery points, said green energy being associated with certificates of origin whose economic value is proportional to the energy produced, each delivery point having at least one consumption counter adapted for computing a total energy consumption at the delivery point, said system comprising:
at least one server associated with said distribution network configured to manage computer connections over one or more communication networks;
a collecting module for collecting credits represented by said certificates of origin, operating in said server;
a partializer for partializing said credits on the basis of purchase orders received from users of said green energy;
a device for storing said partialized credits, held by each user, wherein a current number of credits purchased by said user are stored, said device deducting from said number of credits a quantity of credits on the basis of a corresponding energy consumption that the user is deriving from the renewable and environmentally friendly sources.

16. The system as claimed in claim 15 further comprising:
at least one metering and computing device for each delivery point, the metering and computing device including an input 26 connected to a corresponding outlet of an electrical system served by said counter device for withdrawing energy;
an outlet supplying a point of use or a group of points of use of said energy;
a measuring unit for measuring the energy in transit through said metering and computing device; and,
a computerized control unit configured for measuring said amount of energy in transit, and wherein said storage device for storing the partialized credits includes a memory area that is a part of said metering and computing device, said control unit being programmed with a computing procedure for deducting from the current amount of said partialized credits a sum corresponding to the energy consumption which passed through said metering and computing device.

17. The system as claimed in claim 16, wherein said metering and computing device includes a communication interface for communicating with said server, through said communication networks, said partialized credits being received by said metering and computing device through said communication networks.

18. The system as claimed in claim 16, wherein said memory area is physically removable from said metering and computing device, and is constituted by a re-writable permanent memory card having a USB interface.

19. The system as claimed in claim 15, wherein said metering and computing device includes a current switch, controlled by said control unit and configured for interrupting the energy supply to the user connected thereto when the partialized credits are used up.

20. The system as claimed in claim 15, wherein said metering and computing device a units of measure converter, for executing a conversion procedure that operates in said control unit, configured for immediate converting of readings of consumed energy into a corresponding value in terms of the certificates of origin, and for transmitting said value to a display associated with said measuring device.

21. The system as claimed in claim 15, wherein said delivery point is an energy point of sale accessible to a plurality of users, said delivery point having a device for delivering-counting delivered energy, and being provided with an interface, compatible with a corresponding interface of said storage device carrying the partialized credits, the storage device comprising a re-writable permanent memory, connectable to said delivering-counter device, so as to obtain a subtraction of said credits deriving from the certificates of origin in proportion to energy withdrawn from said point of sale.

22. A method for managing consumption of green energy derived from renewable and environmentally friendly sources introduced into a power distribution network together with energy produced by other sources, for undifferentiated distribution therewith to predetermined delivery points, said green energy being associated to certificates of origin, whose economic value is proportional to the energy produced, said power distribution network including, in each delivery point, at least one consumption counter for computing total energy consumption in a plant served thereby, said method comprising:
collecting credits related to said certificates of origin in a server associated to an administrator of said power distribution network or independent therefrom, said server managing computer connections via one or more communication networks;
partializing said credits on a basis of purchase orders coming from users of said green energy; attributing said partialized credits, in a predetermined amount, to the users who have paid a corresponding amount;
deducting from said amount a number of credits on the basis of the corresponding energy consumption that the user determines to derive from renewable and environmentally friendly sources, said corresponding energy being provided through an energy delivering device having an energy metering and computing device, interacting with said storage device which stores the partialized credits, and adapted for carrying information about the amount of credits purchased by the user.

23. The method as claimed in claim 22, wherein said energy metering and computing device has a communication interface for communicating with said server, through said communication networks, and in that said subtraction of said partialized credits based on the corresponding consumption is effected by a real time interaction of said metering and computing device with said server.

24. The method as claimed in claim 22, wherein said subtraction of said partialized credits on the basis of the corresponding consumption is effected by cancelling a portion of the partialized credits on said storage device associated with said metering and computing device.

25. The method as claimed in claim 22, wherein said metering and computing device includes a device for connecting to an electric socket and being provided with at least one socket and a metering unit for measuring the energy in transit, said subtraction of the amount of energy consumed through said at least one socket being performed by connecting said storage device for carrying partialized credits to said metering and computing device, and then subtracting an amount proportional to the consumed energy from said credits.

26. The method as claimed in claim 25, wherein said storage device for carrying partialized credits are fixedly installed in said metering and computing device.

27. The method as claimed in claim 25, wherein each storage device for carrying partialized credits is physically independent, being a re-writable permanent memory card, installed in said metering and computing device when said green energy is consumed.

28. The method as claimed in claim 25, wherein each storage device for carrying partialized credits is a dedicated memory area placed under control of said server.

29. The method as claimed in claim 22, wherein said delivery point is an energy point of sale accessible to a plurality of users, said delivery point having a delivering-counter device provided with an interface compatible with a corresponding interface of said storage device for carrying partialized credits, and wherein said subtraction of an amount of credits proportional to the amount of delivered energy is carried out upon connection of said storage device to the interface present in said delivering-counter device.
